(19) United States
(12) Patent Application Publication
(10) Pub. No.: US 2017/0031562 A1
(43) Pub. Date: Feb. 2, 2017

(54) System and Method for Human Sexual Relationship Enhancement

(71) Applicants: Daniel Hiram Waters, Quinton, VA (US); Timothy Moffett Waters, Hiram, GA (US); Maximilian Grant Myers, Richmond, VA (US); Ernest Lee Hawkins, JR., Richmond, VA (US); Michelle Rene Downey, Richmond, VA (US)

(72) Inventors: Daniel Hiram Waters, Quinton, VA (US); Timothy Moffett Waters, Hiram, GA (US); Maximilian Grant Myers, Richmond, VA (US); Ernest Lee Hawkins, JR., Richmond, VA (US); Michelle Rene Downey, Richmond, VA (US)

(73) Assignee: OPEN ISLAND, LLC, Hiram, GA (US)

(21) Appl. No.: 14/812,742

(22) Filed: Jul. 29, 2015

(51) Int. Cl. G06F 3/0481; H04L 12/58; H04L 29/08; G06F 3/16

(52) U.S. Cl. CPC G06F 3/04817; G06F 3/167; H04L 51/32; H04L 67/306

(57) ABSTRACT

A libido measurement icon displays messages related to a partner user's sexual arousal level on the display of a user's devices, such as Smartphone or tablet, having Internet connectivity. When a user or partner user activates the icon, the icon will display messages received from partner users related to the partner user's current level of sexual arousal and will allow a user to submit the user's own libido level (a “libido score”) to a partner user via the libido measurement system's messaging function.

### CROSS-REFERENCE TO RELATED APPLICATIONS

This application claims the benefit of U.S. Provisional Application No. 62/032,677, filed Aug. 4, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to mobile software applications, and in particular, to mobile software applications that allow for quantification and communication of sexual arousal as well as the promotion, acceleration, and enhancement of human sexual behavior between and among consenting adults that includes, but is not limited to, sexual intercourse.

### PRIOR ART

Included for reference and discussion are several patents that encompass various systems and methods for the promotion of more fulfilling sexual encounters.

U.S. Pat. No. 8,579,837, Nov. 12, 2013, Joshua Makower—This patent describes a device for human female sexual enhancement to aid in the promotion of intercourse with a partner. Claims are limited to a device that must be manually obtained, held and used by a person. It is not discrete, in that, it can't be used in the workplace, shopping mall, church or other social gatherings. It is not a software application, nor does it require the use of a software application to enable use by said person.

U.S. Pat. No. 8,144,007, Mar. 27, 2012, Edward F. Tuck—This patent discloses a relationship prediction system using software applications, specifically a database management system, to store information to be used by the end users of the software application using a web based entry mechanism. Said information includes a personal profile and a genetic profile using means understood in the art of genetic research. This invention is limited to aiding to increase the odds of a couple match during the introductory period of a relationship and not later stages of human relationships involving sexual intercourse between said couples or among a plurality of consenting adults.

U.S. Pat. No. 8,128,409, Mar. 29, 2007, Richard Feller—This patent discloses a method and system to improve interpersonal communication between users regarding any subject matter, within in the context of a computer processing system with a well-defined user interface coupled with software enablement. This invention is merely used to aid in improving communication amongst a group of users in a formulaic fashion, i.e. with questions and answer weighting; and comparison of the same. However, the invention is distinctive from that of the present disclosure in that the mechanisms to arrive, or culminate, in sexual intercourse are vastly different.

U.S. Pat. No. 7,940,174, May 10, 2011, Edward F. Tuck—This patent discloses a method and system to predict the likelihood of a match between potential couples using a question and answer format for the user interface using a computer processing system. This invention is limited to aiding to increase the odds of a couple match during the introductory period of a relationship and not in later stages of human relationships involving sexual intercourse between said couples or among a plurality of partners.

### ADDITIONAL REFERENCE AND RESEARCH

Recent research suggests that men think about sex around 19 times per day, on average and that women think about sex around 10 times per day on average: http://www.cbsnews.com/news/men-think-about-sex-every-7-seconds-what-study-says/

In addition, women tend to be more influenced by external factors such as their environment and their context: http://www.webmd.com/sex/features/sex-drive-how-do-men-women-compare

Recent research also suggests that sex is a key to a happy marriage: http://www.huffingtonpost.com/2014/02/27/sex-and-marital-satisfact_n_4870013.html

### SUMMARY OF THE INVENTION

The present invention is a free standing application for a mobile device that is capable of method for providing from one member partner of a committed relationship to another partner or partners in the committed relationship, a notification of state of arousal, dubbed a libido score. This score is provided on a numeric scale of zero (0) to ten (10), where a zero (0) denotes no sexual arousal or interest in your partner, spouse or group of partners and a ten (10) denotes the highest level of sexual arousal and interest in your partner, spouse or group of partners. A central computer server provides multi-directional notification evens among said members of the committed relationship.

The libido measurement icon displays state of arousal notifications on the display of a user's device, such as a Smartphone or tablet, having Internet connectivity. When a user enters a libido score for the user's partner or partners via the libido measurement icon, the user's partner or partners receives a targeted notification of the libido score within their own instance of the libido measurement icon.

The libido measurement icon is appointed for use with a device having a display screen and Internet connectivity, and wherein the display screen displays a plurality of applications. The icon system is constructed having a libido measurement icon associated with software that includes entry of user preferences associates with the user of the device and the user's partner or partners' data. The libido measurement icon is operative to establish and Internet connection between the device and the libido measurement icon software. When triggered, the libido measurement icon allows the user to enter libido scores for the user's partner or partners, to send the notification to the partner or partners' mobile computing device, and to receive notifications and messages sent from the user's partner's or partners' mobile computing devices.

The libido measurement icon is displayed on the touchscreen of a Smartphone or tablet that has Internet connectivity. Activation of the icon is automatically in standby. Its main feature is to provide libido scores to a partner's device or to receive libido scores and related messages from a partner's device. The icon and software is intended for private messaging between and among consenting adults to communicate levels of libido individually. Preferably, for basic service of the app, the user may not have to pay a fee for the icon services. However, there may be provided a premium version wherein the user has advanced user features not offered in the basic service app package. For example, with the premium app version, the user may be able to connect to external apps to plan a date night by reserving hotel rooms, making travel plans, or making dinner reservations in connection with sharing or receipt of a libido score.

### BRIEF DESCRIPTION OF THE DRAWINGS

FIG. 1 is a an overall process flowchart depicting the main methods employed in the present invention;

FIG. 2 is a realization of the computer architecture required to support the present invention;

FIG. 3 is a wireframe drawing showing the login page in the present invention;

FIG. 4 is a wireframe drawing showing the initial signup page in the present invention;

FIG. 5 is a wireframe drawing showing the second page of the signup process in the present invention;

FIG. 6 is a wireframe drawing showing the partner view in the present invention;

FIG. 7 is a wireframe drawing showing the wheel control and main screen in the present invention;

FIG. 8 is a wireframe drawing showing the edit profile page in the present invention;

FIG. 9 is a wireframe drawing showing the pending request in the present invention;

FIG. 10 is a wireframe drawing showing the add partner interface page in the present invention;

FIG. 11 is a wireframe drawing showing the settings control page in the present invention;

FIG. 12 is a process flowchart depicting showing the libido scoring method in the present invention; and

FIG. 13 is a wireframe drawing showing the popup page for adding a partner in the present invention.

### DETAILED DESCRIPTION OF THE INVENTION

This invention relates to a libido measurement icon that allows users to rate arousal levels and to share that information with specified partner users within the display of a user's devices, such as Smartphone or tablet, having Internet connectivity. When a score is generated by a user, at least one notification from a libido measurement partner user is sent from or displayed on the Smartphone or tablet device.

Uniquely, the system displays a partner libido score on the display screen of a Smartphone or tablet device of a user and allows corresponding entry of the same; these scores are specifically generated among partner users and are not communicated outside of designated users. A free standing libido measurement application is provided. The mobile app requires the user to enter preference data including demographic information of the user and partner users of the app. The libido measurement app connects the user to a remote database present in the Internet that facilitates communication among partner users. A filter present in the remote database only provides messages in the Smartphone that meet the preferences of the user. In a preferred embodiment, each time the user clicks the mobile device app the preferences page is presented. The user may add a new desired item or select a previously provided item; and only notifications that relate to specific partner users will be presented in the Smartphone.

The libido measurement Internet messaging system provides a message icon displayed on a Smartphone, a tablet or a mobile device, or stationary computer device, having a display screen and Internet connectivity. Advantageously, the libido measurement Smartphone application of the present invention empowers users, either directly or indirectly (through commercial dating services); to deliver targeted messages concerning libido ratings to specified partner users through targeted notifications on the users' Smartphones. The libido measurement application attracts and excites a diverse audience of Smartphone users or mobile devices with a mobile application that allows them to send and receive notifications and alerts on sexual arousal levels specific to their chosen partner users. Uniquely, the subject libido measurement application allows a user to rate the user's own libido and to instantaneously send that rating to a partner user so that the partner user is quickly made aware of the sender's level of sexual arousal. A data warehouse is established with a robust reporting tool that captures usage data.

Customer installation of the libido measurement application is readily achieved through use of an easy usable interface, including location based notification and alerts. Incorporation of multimedia applications such as HTML5, video. Flash, and the like is provided for use with the messaging function of the app. An application referral program may also be provided. Members/customers can further be kept informed of the libido measurement application features by way of an opt-in email newsletter tool, automatic pop-up tools, and the like, which can further be tailored for specific user preferences. Links to social media networking sites such as those under the trade names Facebook, Twitter pages, and the like, can also be provided through the libido measurement application.

The libido measurement application also provides a web portal for advertisers, wherein an easy to use interface supports multiple ad campaigns (various advertiser accounts). Simultaneous add campaigns within the same advertiser account are also supported by the systems platform. Agency-managed ad campaigns, including multiple ad campaigns within multiple advertiser accounts managed within each ad agency account, are readily supported by the application platform. Each customers account information is protected in a secured environment to ensure confidentiality of personal information. An administrative level account management feature is integrated within the application's platform to allow system administrators the ability to effectively market the mobile application to potential users by providing custom offerings and promotions, and the ability to track advertiser account payment status. Further, an advertising cost charging model is provided that supports pay-per-click and ad placement bidding, discount/coupon distribution via barcodes. Multimedia applications, such as HTML5, video, Flash, and the like, are further utilized by the libido measurement application.

A reporting tool is provided through the libido measurement application for providing reports to users through an easy to use interface. The reporting tool captures and stores all fields in the data warehouse to allow robust reporting and the ability to create ad hoc reports to allow users to create their own custom reports. Reports may be automatically generated on scheduled intervals, such as via a given time interval (i.e. day 2), thus allowing users to track the status of their usage of the application and compile data related to user and partner libido scores over a period of time.

A diverse audience is appointed to utilize the subject libido measurement smart phone/mobile device application. Users of the application include users having the user installed mobile application downloaded on their mobile device, including Smartphones and mobile tablets with data usage enabled.

The libido measurement icon is displayed on a touch screen of a Smartphone or mobile tablet device having Internet connectivity. The libido measurement icon displays on the screen automatically when the device receives a libido measurement notification from a partner user. The libido measurement application may provide an audible sound as well as the visual indicator. The user can have the libido measurement messaging system activate automatically (push notification), or the user can elect to manually activate the messaging system. Wherein the app notifies the user of a message from a partner user, the user can then either select or activate the app for more information by touching the icon, or the user can select ignore the app. If the user selects to activate the information to be displayed by the app, the user touches the icon which in turn triggers Internet connectivity between the Smartphone or tablet and the host server for the application, which will send along the messages from the partner user for display on the user's mobile computing device.

A notification window pops-up on the user's Smartphone display when the app receives a notification that a partner user has sent a message. Within that window, the user has the option to navigate by 1) clicking the notification. 2) saving the notification, or 3) deleting the notification. If the user clicks on the notification, the application icon launches the app screen detailing the content of the partner user message. If the user clicks “keep”, the message is stored or saved in a saved deals queue of the user. If the user wishes to ignore the notification, the user can delete the notification by selecting “X” or the like, removing the message from view.

Smartphones and mobile tablets contemplated herein comprise any of commonly available Smartphones including but not limited to those sold under the trade names iPhone, iPad, HTC Inspire, Freestyle, HD7S, Surround, LG Quantum, Encore, Phoenix, BlackBerry Bold, Torch, Pearl 3G, Curve, Samsung Solstice, Focus, Captivate, Infuse, MOTOROLA ATRIX, FLIPSIDE, Google tablet, and HP Veer 4G.

A user's Smartphone or tablet device generally includes installed software adapted to generate the libido measurement icon and display same on the display screen of the Smartphone or tablet. An actuating means is provided for actuating the libido measurement icon through use of a touch sensitive Smartphone or tablet screen. Touching the libido measurement icon launches the linked web page through Internet connectivity. Software for displaying the libido measurement icon and matching preferences with GPS location is provided. GPS enabled software is provided in association with the Smartphone or tablet which communicates with the software for providing location of advertisers and user's for correlation of user preferences.

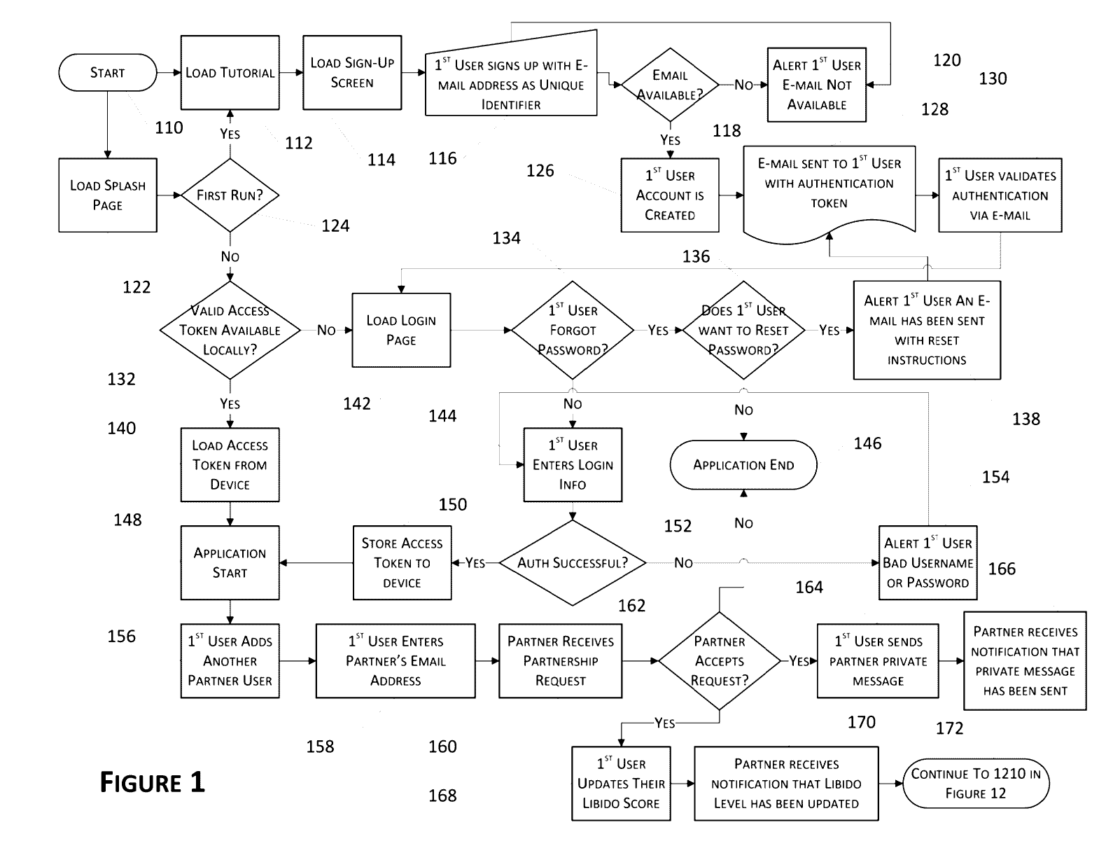

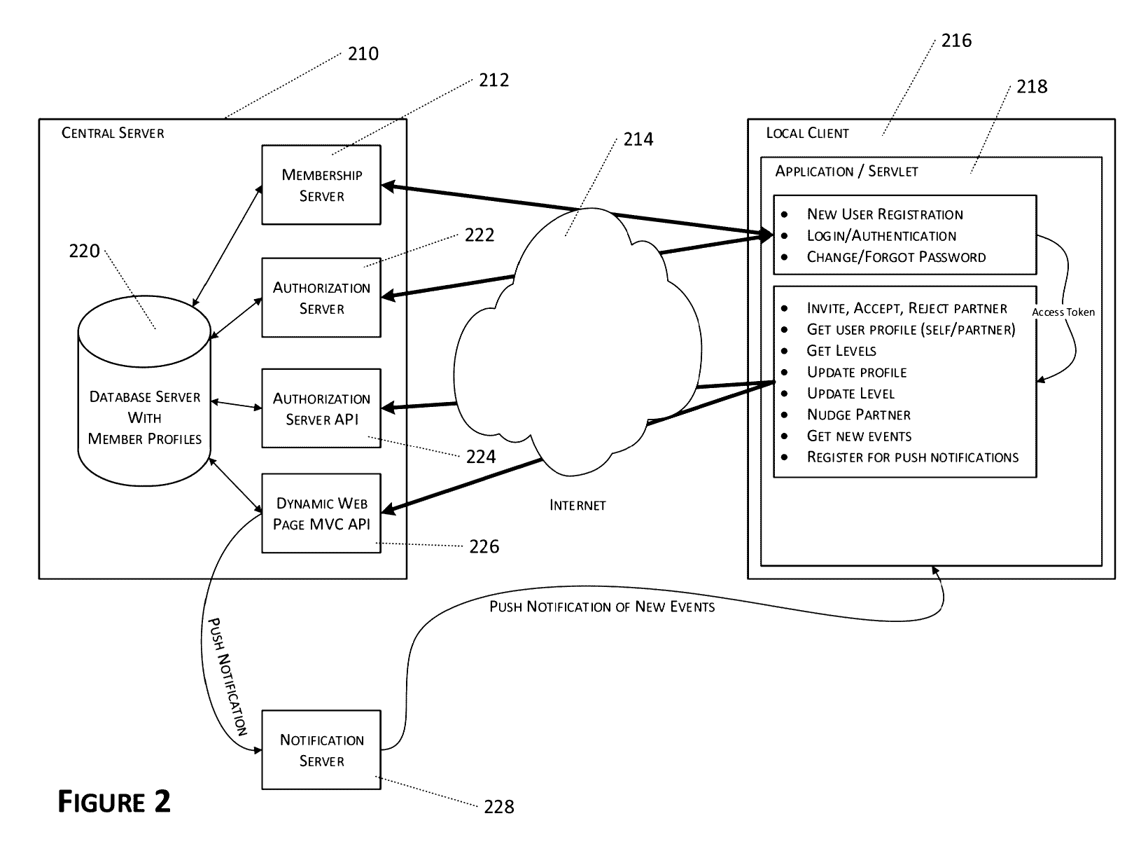

Referring now to the invention in more detail, in FIG. 1 there is shown the overall process flowchart. The preferred embodiment requires the use of a client-server (2-tier) computer architecture, described in FIG. 2. For the remainder of this disclosure, the computational and automated embodiment of the process will be known as the “Application”, both for the server side and the client side view of the processing. To start the process in FIG. 1, step 110, a 1^{st} User will start the Application on their client device, typically a mobile computing device but not necessarily limited to this form of computing hardware. In FIG. 1, step 122 shows the load of an initial splash page with logos and then introspects from a locally stored token if this is the initial run of the client side Application in 124. If “no”, then the process continues to 132 to validate that a local access token exists. From 124, if “yes”, the process branches into 112 and a tutorial loads, followed by a sign-up screen in 114. The 1^{st} User then enters their email address. The Application then checks the remote operating system of the server computing device to ensure that that specific email exists in the server side database, show by 118. If it exists, i.e. “yes”, then the Application will create an account as shown in 126 on the Application server side. If the email client does not exist, i.e. “no”, then the Application will notify the 1^{st} User that that email has already been used, which will then loop back to 116 to try again.

Once the 1^{st} User account is created in 126, an email is sent to the 1^{st} User that contains the authentication token, which is stored locally on the client computing device, typically a mobile device or smart phone as shown in 128, and then this is validated using the local email client of the client side computing device in 130. At that point, processing continues to 142 with the load of the login page. From there, the 1^{st} User then enters their login information in 144, assuming they didn't forget their password in 134. When the authentication is successful in 152, the access token is stored on the client side computing device in 150. Then the Application starts in 148.

Should the 1^{st} User forget their password, as noted in 134, a sub-process is executed in the Application where the user can reset their password, 136; receive a new email with reset instructions in 138; which in turn sends the user back to 128 to get a new authentication token. If the user does not wish to reset their password in 136, the Application will come to an end, as show in 146.

Referring in more detail to FIG. 1, continuing from 132, the access token is loaded locally from the client side computing device in 140 and then Application starts in 148. In order to realize full value of this Application, the 1^{st} User must add a Partner User as denoted in 156 in FIG. 1.

For the remainder of this disclosure, the term “Partner User” is meant to imply that the 1^{st} User and Partner User are in a committed sexual relationship. In both cases, the relationship is also implied to be monogamous, but does not necessarily have to be. With this Application, a plurality of partner pairs or plurality of polyamorous groups can exist within the system, not just this exemplary pair denoted herein as 1^{st} User and Partner User. An alternate embodiment includes the ability for the 1^{st} User to pair up with multiple partners in a “1 to many” fashion should the intent of the use of the Application change by the 1^{st} User.

In 158, the 1^{st} User enters the Partner User email address. In 160, the Partner User receives the partnership request and may decide to accept or reject this partner, or coupling, request as seen in 162. If the User Partner wishes, they may reject the request and the Application will end in 146. In reality, the User Partner will most likely accept this request. It should be noted that the use of the Application implies that there are at least two coupled users and that the interest in using the Application is worked out in advance using any means of communication necessary.

Described also in FIG. 1 is the ability for the 1^{st} User and Partner User to communicate using a private message chat system as denoted in 164 and 166. This communication mechanism is meant to be bi-directional and well known in the art. It is mentioned here as an end user requirement to send personal, secret and encrypted messages back and forth, without a persistent storage means. This feature, while well known in the art, is required to enhance the quality and frequency of communication of a couple in a committed relationship. It is the opinion of the inventors that this feature serves to enhance the relationship of the couple or polyamorous group as a whole, which is the overall purpose and intent of this Application.

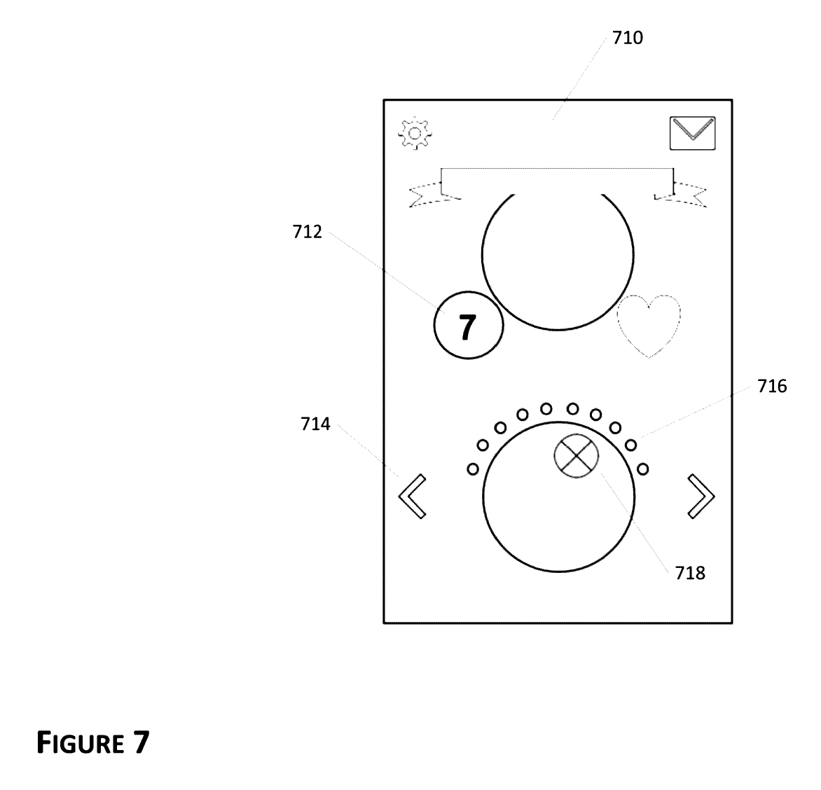

Referring in more detail to FIG. 1., the 1^{st} User, if they wish, may leverage a mechanism in the Application, denoted by 168 and depicted later in FIG. 7., to send to the Partner User, using a communication or notification, their level of sexual interest, referred to herein as a Libido Score. The communication or notification to the Partner of the Libido Score could be provided as a sound cue, a pre-recorded message of the 1^{st} User, for example, for the Partner User to hear. The Libido Score is initially set to zero (0) which implies no sexual arousal or interest in the Partner User. Upon a change in Libido Score as denoted in 168 to value other than zero (0), the Application will send a non-verbal reply notification to the Partner User shown in 170 to let them know that they are more (or less) interested in them sexually, for example, by changing their Libido Score to a four (4) in 168. At this point, the process, or loop, may continue as denoted in 172 in FIG. 1.

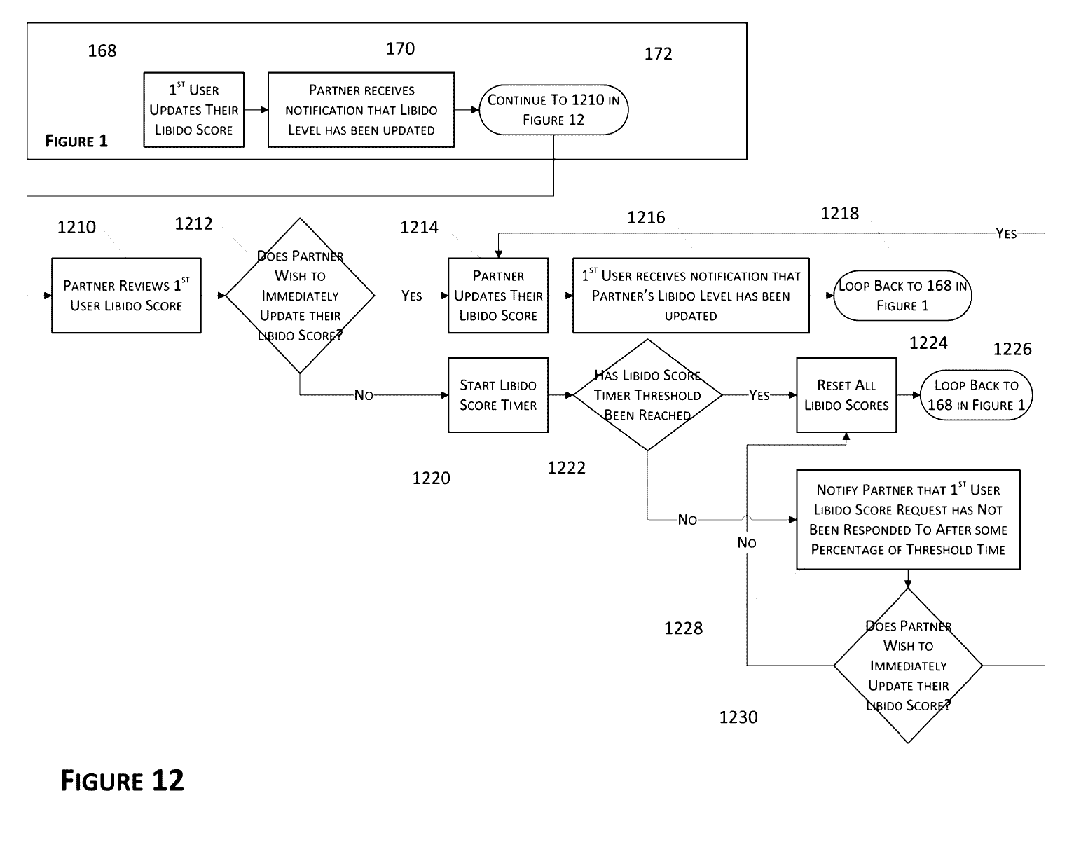

Referring now to FIG. 12, the Partner reviews the Libido Score of the 1^{st} User in 1210, wherein they may wish to reply non-verbally to the 1^{st} User by updating their own Libido Score in 1212 and 1214. In order to promote the continual non-verbal communication between the 1^{st} User and the Partner, a Libido Score timer is started in 1220. The threshold for a reply using the Application is set to a pre-determined value. In the current embodiment, as reasonable timeframe may be on the order of a few minutes, and in alternative embodiments, the threshold could be any reasonable timeframe from seconds to days. The Application will evaluate the current time to the reply threshold in 1222. If the reply threshold has been reached or exceeded, all Libido Scores are reset to zero (0) in 1224 and the process loop may continue back to 168 in FIG. 1. If the evaluation of the reply threshold has not yet been reached in absolute time, then 1228 in FIG. 12 will provide a notification locally to the Partner that they have not yet responded and will remind them to do so. The interval of local notification will typically be a percentage of the overall reply threshold, for example, in increments of 25%, whereby local notifications will be generated by 1228 at 25%, 50%, and 75% of the reply threshold. In alternate embodiments, the incremental percentage of the reply threshold can be any reasonable set of percentages, for example at 10%, 40%, 80% and 90%. In FIG. 12, upon the local notification reminder being sent to the Partner screen, they may wish to reply with an update to their own Libido Score in 1230 by looping back to 1214. At that point, a push notification will be sent to the 1^{st} User in 1216 that their Partner has updated their Libido Score. From here, the process loops back to FIG. 1, step 168.

Referring now to FIG. 2, the computer architecture of the Application is defined in the preferred embodiment, noting that alternate embodiments may have different components noted in different locations. In 210, the central server of the Application is shown, which is built upon a computing device containing a central processing unit (CPU), local random access memory, persistent data storage (local disk drives, SAN attached storage, or NAS based storage), intra- and inter-communication busses and interface cards. Referring to 214, external to the computing device and well understood in the art are some external components such as local area networks, wide area networks and any manner of inter-connectivity required to provide the communication mechanisms between the central server of the Application and the local client or computing device denoted in 216. The local computing device has been referred to as a “smart phone”, “mobile device”, or “tablet”, but this does not preclude the use of other, not-yet well-known localized computing devices or personal computers. In the preferred embodiment, each 1^{st} User and Partner couple user of the Application would have access to their own local client based computing device able to support the Application, i.e. a smart phone, tablet, etc.

Again referring to FIG. 2, a tertiary component of the Application is the Notification Server, denoted in 228, m which handles bi-directional, non-verbal message notification between any 1^{st} User and their respective Partner, for each “1^{st} User/Partner” couple using the system.

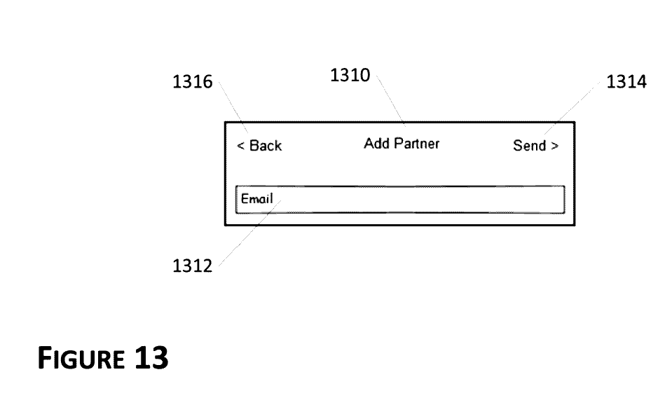

Referring in more detail to 210 in FIG. 2, 220 shows the use of a persistent storage method, typically a database server or manager in the general sense and well understood in the art. The database in 220 is used for the persistent storage of member profiles, Libido Scores for each member, as well as the other meta-data as noted above (referring again to 1233 and 1324 in FIG. 13). The data stored for every user of the Application includes, but is not limited to, other meta-data constructs around physical location, obtained from the GPS of the users' mobile computing device, time and date of the change in Libido Score for every user, and time and data of the usage of the Application by any user. Other data may be required to be stored in 220 that should be well understood to someone skilled in the art. Additional components required to reduce this invention to practice are a Membership Server (212), an Authorization Server (222), an Authorization Server Application Programming Interface (API) (224); and a Dynamic Web Page Model-View-Controller (MVC) API denoted in 226.

Referring in more detail to FIG. 2, 218 provides the local client side programming aspects of the Application required to enable the invention in the preferred embodiment. The local application/servlet side of the Application will perform numerous tasks, including but not limited to (1) new user registration; (2) login and authentication; (3) password updates; (4) invite, reject and accept partners; (5) pull the user profile to local device; (6) pull the Libido Scores to the device; (7) push or update Libido Scores to the central server; (8) nudge or notify/message the Partner of a 1^{st} User; (9) get any other new events from the central server; (10) register for notifications; and (11) allow to push to or pull from the central server to the local client device potentially any of the meta-data stored in the database server (220) of the Application.

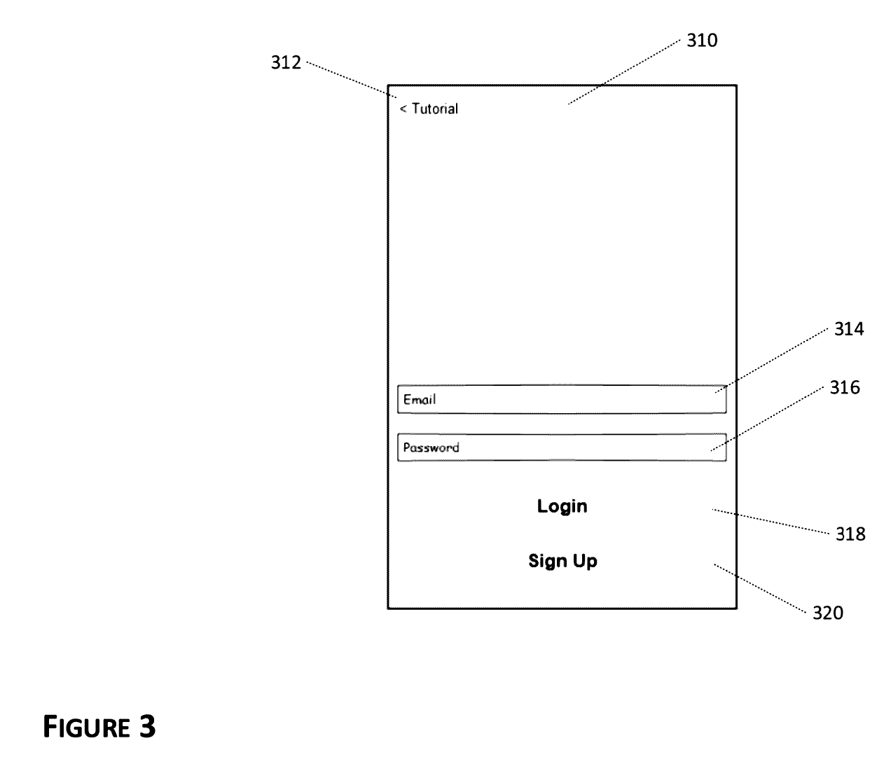

Referring now to FIG. 3, the login screen is presented as a wireframe mockup in 310. 312 provides a button any user may select to read a textual tutorial on how the Application works. The entry field denoted by 314 allows the user to enter their email address and 316 provides the entry screen for their password. Once entered, the user selects the button denoted in 318 to log into the Application. If this is the first time a user has used the Application, they can select the “Sign Up” button denoted in 320.

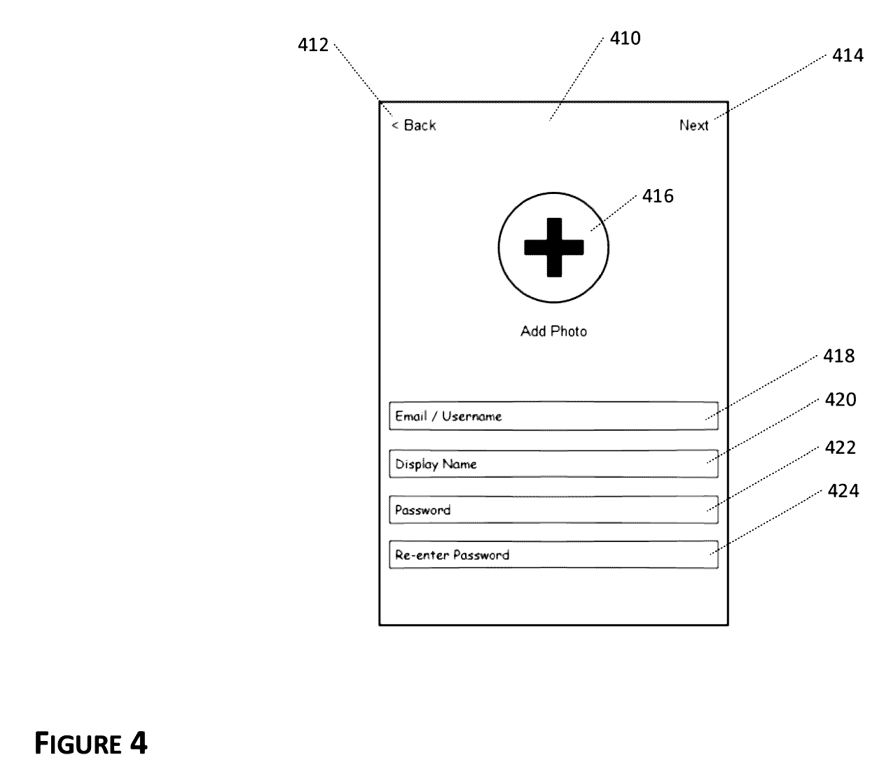

Referring now to FIG. 4, a new user will be presented with the first of two (or more potentially in alternate embodiments) sign up screens in 410. The button in 412 provides a means to go back to the previous screen, known in the art as a “bread crumb”, while the button in 414 takes the user forward to the next screen. The button denoted as 416 allows the user to upload a photograph to represent their “avatar” for the Application. The field denoted in 418 provides a new user the ability to enter a unique email address, also simultaneously used as their login name or system username. Field 420 provides a new user the ability to input their own display name, which is used for all non-verbal communications aspects of the Application between the 1^{st} User and the Partner User. Fields 422 and 424 provide a new user the ability to select a password. When completed by a new user, the Application will allow a new user to proceed by selecting the next button denoted in 414.

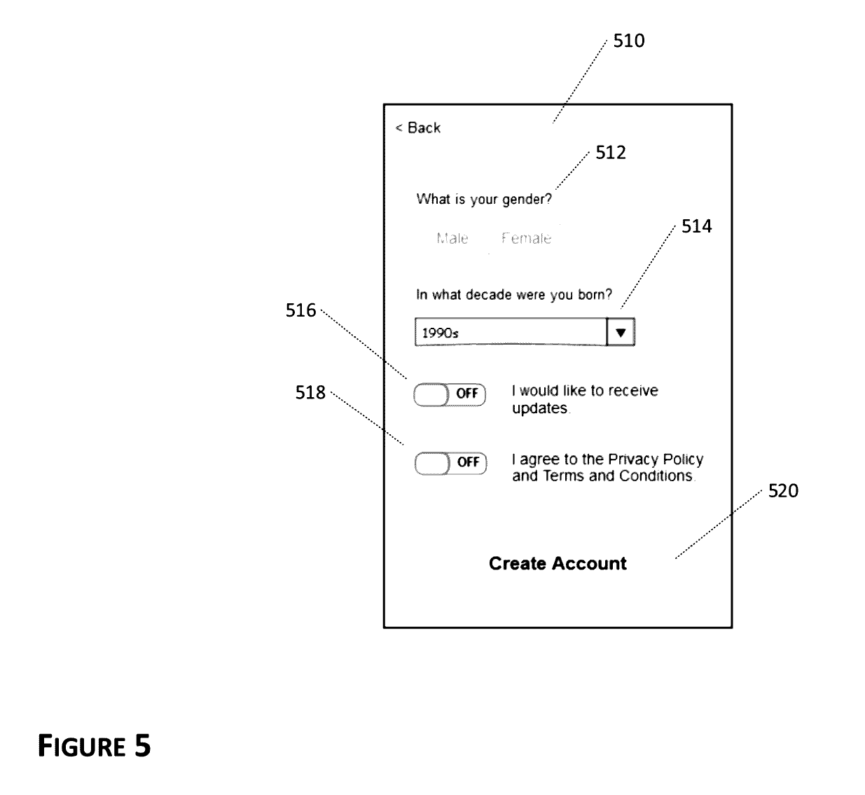

Referring now to FIG. 5 and considering the same new user, the Application provides a new user the button in 512 to select their gender. The combo box denoted in 514 provides a pick list of decades from which to select their birth year. The radio button denoted in 516 allows a new user to select whether they would like to receive electronic updates. The radio button in 518 provides a new user the ability to select whether they accept the terms and conditions as well as privacy policy of the Application. Once entered, a new user will be able to select the button denoted in 520 to create their new account.

Referring in more detail to FIG. 5, should a New user have a conflict with their unique email address, the Application will provide an informational message to that affect and return a New user to FIG. 4 to re-enter a unique email address denoted by field 418 in FIG. 4. Likewise, should the minimum password restrictions not be met, as determined by the Application, a New user will be asked to enter a new unique password denoted in 424 in FIG. 4.

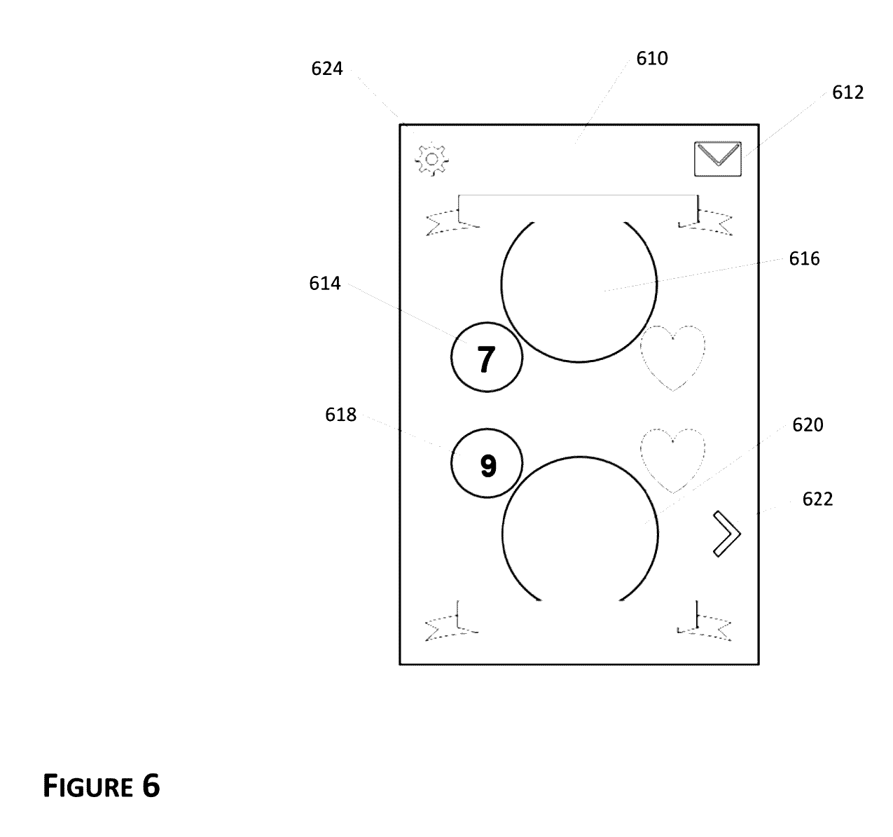

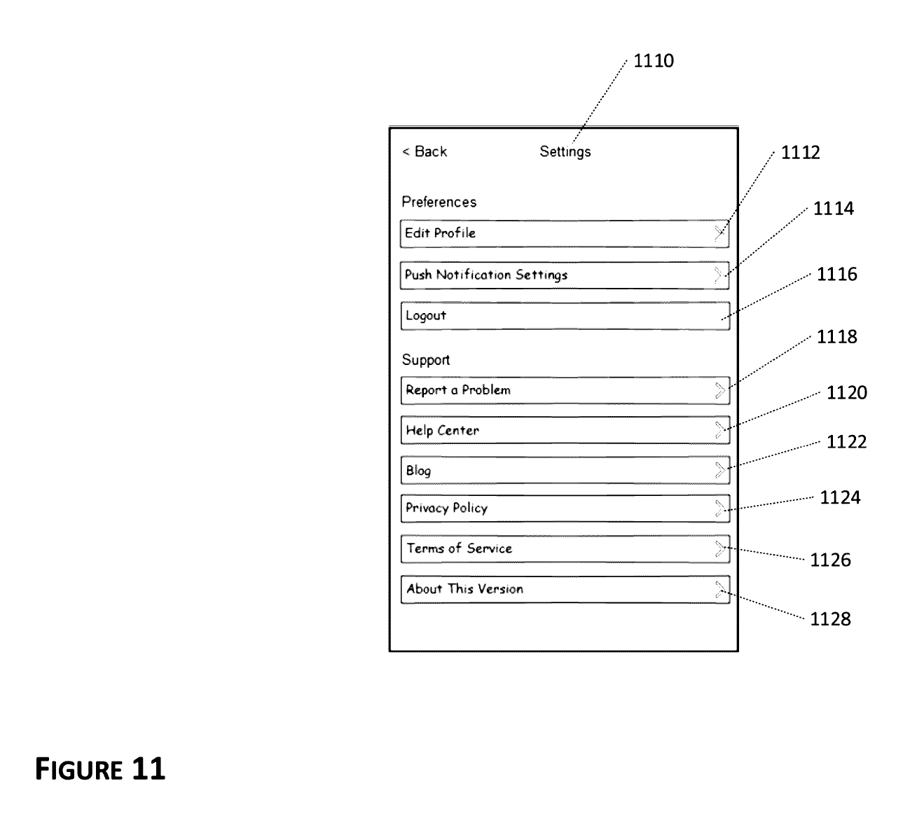

Referring now to FIG. 6, the partner view screen is presented in 610. The point of view for this FIG. 6 is from the perspective of the 1^{st} User. The button denoted by 612 allows the 1^{st} User the ability to send to their Partner User a private, non-persisted, non-verbal, and textual based electronic message. The display in 616 shows the 1^{st} User's avatar, as selected previously. Similarly, the display in 620 shows the avatar of the Partner User. The display bubbles denoted in 614 and 618 show the current Libido Scores of the 1^{st} User and Partner User respectively. At any time, the 1^{st} User may elect to select the chevron denoted by 622 to move to the next screen denoted in FIG. 7. At any time, the 1^{st} User may elect to review or adjust their settings by selecting the button denoted in 624. This will take them to another screen depicted in FIG. 11, discussed further below.

Referring now to FIG. 7, the 1^{st} User is presented with the “Wheel View” screen or page in 710. Here, the 1^{st} User has the ability to see their current Libido Score denoted in 712. Should the 1^{st} User wish, they may move the graphically generated wheel icon denoted in 718 much like adjusting any physical knob, e.g. a volume control on a radio. When moving the wheel in 718, the Libido Score of the 1^{st} User will change and the currently selected Libido Score will show in the screen denoted by 716. Once the 1^{st} User is satisfied with their Libido Score selection, they can select the chevron denoted in 714 to be taken back to the screen denoted in FIG. 6. Simultaneously, once the chevron denoted in 714 is selected, the Application will send to the Partner User of the 1^{st} User a notification that the 1^{st} User has updated their Libido Score and said Libido Score will be available to be seen by the Partner User in near-immediate fashion, taking advantage of the speed of notification messages sent through the computer enabled Application and the speed of the Internet as a whole. Here, Internet, as understood in the art, is referring to the entire global intercommunications network in the general sense.

Referring in more detail to both FIG. 6 and FIG. 7, it is important to note that the 1^{st} User and Partner User may at any time review their current Libido Scores of both themselves and their partner, select new Libido Scores, and send private messages in a continuous and cyclical fashion, potentially resulting in a sexual encounter between the 1^{st} User and the Partner User. Likewise, the data associated with the exchange of Libido Scores, physical location of the 1^{st} User and Partner User, and other potential meta-data about use of the Application or otherwise, would be stored for the couple in the central database server for review by the couple as needed.

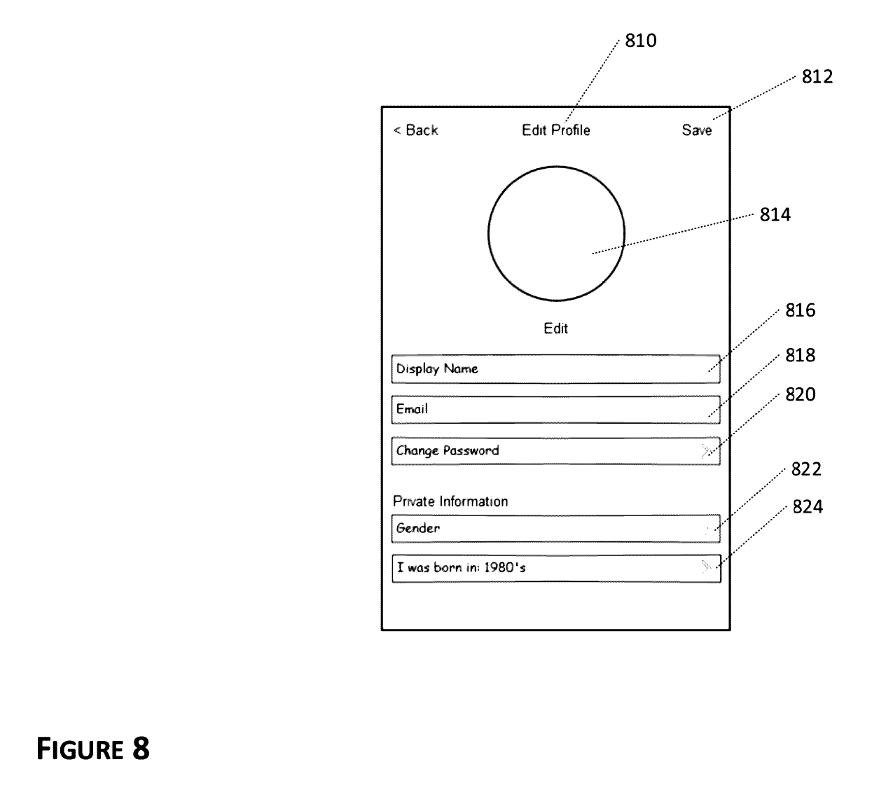

Referring now to FIG. 8, a user is presented with the edit profile screen in 810. Here, as user may select a new avatar picture denoted in 814, change their display name in 816, change their personal password in 820, or adjust their gender and data of birth range in 822 and 824 respectively. Once the user wishes to save updated values, they will select the button denoted in 812 to save their profile to the Application.

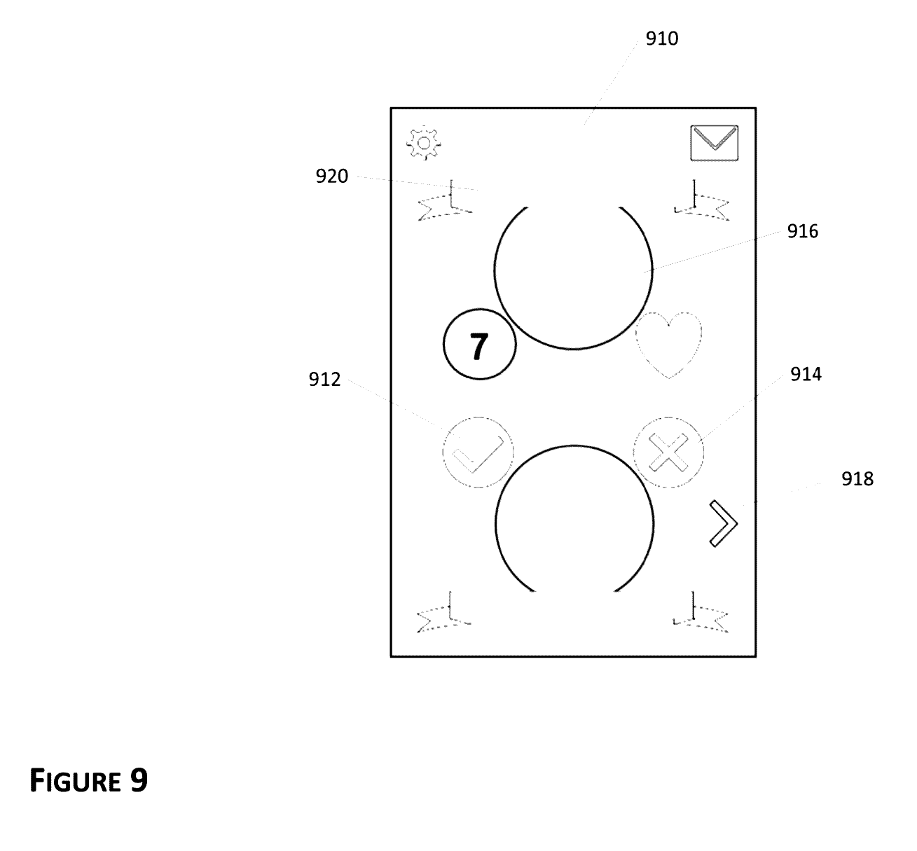

Referring now to FIG. 9 and from the user perspective of the Partner User in 910, the Partner User, most likely shortly after both the 1^{st} User and Partner User agree to use the Application, will receive a notification that another user of the Application wants to pair or couple with them. Their avatar picture will appear in the graphic display in 916 along with their chosen display name in 920. The Partner User has the option to either accept the invitation to pair or couple by selecting the button denoted in 912, or reject their request by selecting the button denoted in 914. Once selected, the Partner User may elect to then leverage the now active chevron denoted in 918 to update their own Libido Score.

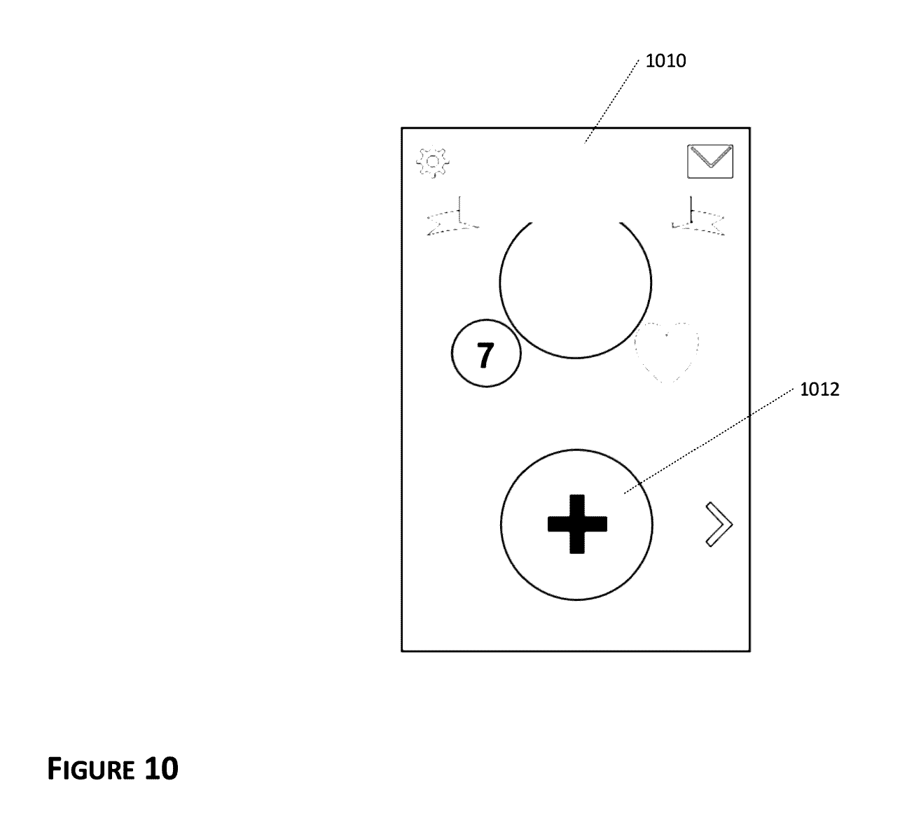

Referring now to FIG. 10 and from the perspective of the 1^{st} User in 1010, the 1^{st} User must send a request to the intended Partner User to pair or couple by selecting the button denoted in 1012. At this point, the Application will pop up a screen for the 1^{st} User to enter an email address.

Referring now to FIG. 13, the 1^{st} User adds their Partner User in 1310. This is accomplished by entering the Partner User's email address, as they have registered in the Application, in the field denoted in 1312. Once entered, the 1^{st} User will then select the send button denoted in 1314, while also having the option to go back to the screen denoted in FIG. 10 by selecting the back button denoted by 1316 in FIG. 13.

Referring now to FIG. 11, any user may adjust the user's own individual settings from the setting screen in 1110. Contained herein are numerous settings options including the following: (1) editing their personal profile in 1112; (2) altering their push notification settings in 1114; (3) logging out of the Application in 1116; (4) reporting a problem as denoted in 1118; (5) contacting the help center in 1120; (6) using the blog service provided by the developers of the Application denoted in 1122; (7) reviewing the privacy policy in 1124; (8) reviewing the terms of service denoted by 1126; or (9) reviewing the version information of the Application. Alternate embodiments may include different capabilities or omit some of the capabilities mentioned herein relating to user and session self-management.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A libido-measurement icon system for indicating level of sexual arousal for use with a device having location-identifying technology, a display screen, and internet connectivity, and wherein said display screen displays a plurality of applications, said icon system comprising:
a. a libido measurement icon associated with software that provides entry of user preferences associated with a user of said device and data related to level of sexual arousal;
b. said libido measurement icon having Internet connectivity for downloading and displaying at least one message related to said user preferences and generated from either a first user from said first user's device or a partner user generated from said partner user's device;
c. said libido measurement icon being operative to establish an Internet connection between said device and the libido measurement icon software for downloading data onto said device, said libido measurement icon being operative to retrieve downloaded data from said device, wherein said system executes logic means to determine display of messages from said first user or said partner user; and
d. said libido measurement icon only displaying said messages when said first user actively inputs request for message display.

2. The libido measurement icon system as recited by claim 1, wherein said device is a mobile phone or Smartphone.

3. The libido measurement icon system as recited by claim 1, wherein said device is a mobile tablet.

4. The libido measurement icon system as recited by claim 1, wherein said device is a computer.

5. The libido measurement icon system as recited by claim 1, wherein no fee is paid by user of said device.

6. The libido measurement icon system as recited by claim 1, wherein a fee is paid by said user of said device for a premium account with said system, wherein said premium account includes advanced functionality associated with said user preferences.

7. The libido measurement icon system as recited by claim 1, wherein said Internet connection between said device and said libido measurement icon software is automatic and display of said messages is periodically refreshed.

8. The libido measurement icon system as recited by claim 1, wherein said user preferences comprise user name, password, gender, age, and identification of partner users.

9. The libido measurement icon system as recited by claim 1, wherein said message to first user indicates said level of sexual arousal of said partner user.

10. The libido measurement icon system as recited by claim 1, wherein said level of sexual arousal is measured on a low-to-high ratings scale within a range of 1 and 10, with 1 indicating a “low-libido” level, 10 indicating a “high-libido” level, and numbers in between 1 and 10 indicating increasing libido ranges as numbers increase from 1 to 10.

11. The libido measurement icon system as recited by claim 1, wherein said libido measurement icon system provides an audible alert when said first user receives a message from said partner user.

12. The libido measurement icon system as recited by claim 1, wherein said Internet connection between said device and said libido measurement icon software for downloading data onto said device is provided by a way of data feed execution.

13. The libido measurement icon system as recited by claim 12, wherein said data feed execution is set to automatically take place at least once during a 24 hour period.

14. The libido measurement icon system as recited by claim 1, wherein said software of said device keeps on running in the background then leverages the device network connection to send or display new messages.

15. The libido measurement icon system as recited by claim 1, wherein said system executes logic means to determine said location of said device relevant to at least one radial distance from at least one location associated with said partner user.

16. The libido measurement icon system as recited by claim 1, wherein said system utilizes a persistent storage method to store information related to member profiles said levels of sexual arousal, device location, and related metadata.

17. The libido measurement icon system as recited by claim 1, wherein said software of said device allows said user to upload photographs to be included as part of said user's profile information.

18. The libido measurement icon system as recited by claim 1, wherein said software of said device allows said user the ability to enter an email address.

19. The libido measurement icon system as recited by claim 1, wherein said software of said device allows said user the ability to enter a unique system user name.

20. The libido measurement icon system as recited by claim 1, wherein said software of said device allows password encryption.

21. The libido measurement icon system as recited by claim 1, wherein said software of said device allows said user the ability to enter a user password for accessing said user profile.

22. The libido measurement icon system as recited by claim 1, wherein said software of said device allows said user the ability to change a user password for accessing said user profile.

23. The libido measurement icon system as recited by claim 1, wherein said software of said device allows said first user the ability to pair with said partner user.

24. The libido measurement icon system as recited by claim 1, wherein said software of said device allows said first user the ability to unpair with said partner user.
